(19) United States
(12) Patent Application Publication
(10) Pub. No.: US 2018/0307496 A1
(43) Pub. Date: Oct. 25, 2018

(54) METHODS FOR GC (GARBAGE COLLECTION) POR (POWER OFF RECOVERY) AND APPARATUSES USING THE SAME

(71) Applicant: Silicon Motion, Inc., Jhubei City (TW)

(72) Inventor: Kuan-Yu Ke, Zhubei City (TW)

(21) Appl. No.: 15/863,896

(22) Filed: Jan. 6, 2018

(30) Foreign Application Priority Data
Apr. 21, 2017 (TW) 106113424

(51) Int. Cl. G06F 9/4401; G06F 12/02

(52) U.S. Cl. CPC G06F 9/4401; G06F 12/0246; G06F 1/30; G06F 2212/2022; G06F 2212/7205; G06F 2212/1044

(57) ABSTRACT

The invention introduces a method for GC (garbage collection) POR (Power Off Recovery), performed by a processing unit, including at least the following steps: after a reboot subsequent to a power-off event, reading a GC recovery flag from a storage unit and determining whether the GC recovery flag indicates that a flash memory needs a POR; and, when the GC recovery flag indicates that the flash memory needs a POR, programming dummy data into a predefined number of empty pages next to the last programmed page of a destination block of the storage unit and performing an unfinished GC data-access operation.

### CROSS REFERENCE TO RELATED APPLICATIONS

This Application claims priority of Taiwan Patent Application No. 106113424, filed on Apr. 21, 2017, the entirety of which is incorporated by reference herein.

### BACKGROUND

### Technical Field

The present invention relates to flash memory, and in particular to methods for garbage collection and apparatuses using the same.

### Description of the Related Art

Flash memory devices typically include NOR flash devices and NAND flash devices. NOR flash devices are random access—a host accessing a NOR flash device can provide the device any address on its address pins and immediately retrieve data stored in that address on the device's data pins. NAND flash devices, on the other hand, are not random access but serial access. It is not possible for NOR to access any random address in the way described above. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. In reality, the NAND flash device always reads from the memory cells and writes to the memory cells complete pages. After a page of data is read from the array into a buffer inside the device, the host can access the data bytes or words one by one by serially clocking them out using a strobe signal.

If the data in some of the units of a page are no longer needed (such units are also called stale units), only the units with good data in that page are read and rewritten into another previously erased empty block. Then the free units and the stale units are available for new data. This is a process called garbage collection. The process of garbage collection involves reading data from the flash memory and rewriting data to the flash memory. It means that a flash controller first requires a read of the whole page, and then a write of the parts of the page which still include valid data. A sudden power off induced by a natural or man-made disaster may damage empty pages next to programed pages of a physical block allocated for a GC procedure, also referred to as a GC block. POR (Power Off Recovery) of a boot procedure is a process to enable the recovery or continuation of a NAND flash system after the sudden power off. In order to prevent the possibly damaged pages from being used in a GC procedure, the POR process programs several dummy pages next to the programmed pages of the GC block each time a boot procedure is executed. However, the POR process may mistakenly program dummy pages when no damage has occurred in the GC block, resulting in wasted space. Accordingly, what is needed are methods for GC POR and apparatuses that use these methods to overcome the drawbacks described above.

### BRIEF SUMMARY

An embodiment of the invention introduces a method for GC (garbage collection) POR (Power Off Recovery), performed by a processing unit, including at least the following steps: after a reboot subsequent to a power-off event, reading a GC recovery flag from a storage unit and determining whether the GC recovery flag indicates that a flash memory needs a POR; and, when the GC recovery flag indicates that the flash memory needs a POR, programming dummy data into a predefined number of empty pages next to the last programmed page of a destination block of the storage unit and performing an unfinished GC data-access operation.

An embodiment of the invention introduces an apparatus for GC POR including at least an access interface and a processing unit. The access interface is coupled to a storage unit and the processing unit is coupled to the access interface. The processing unit, after a reboot subsequent to a power-off event, reads a GC recovery flag from the storage unit and determines whether the GC recovery flag indicates that a flash memory needs a POR. When the GC recovery flag indicates that the flash memory needs a POR, the processing unit directs the access interface to program dummy data into a predefined number of empty pages next to the last programmed page of a destination block of the storage unit and performs an unfinished GC data-access operation.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is the system architecture of a flash memory according to an embodiment of the invention.

FIG. 2 is a schematic diagram illustrating interfaces to storage units of a flash storage according to an embodiment of the invention.

FIG. 3 is a schematic diagram depicting connections between one access sub-interface and multiple storage sub-units according to an embodiment of the invention.

FIG. 4 is a schematic diagram of GC according to an embodiment of the invention.

FIG. 5 is a flowchart illustrating a method for GC data accesses according to an embodiment of the invention.

FIG. 6 is a flowchart illustrating a method for GC POR according to an embodiment of the invention.

FIGS. 7A-7C are schematic diagrams of GC according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It should be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

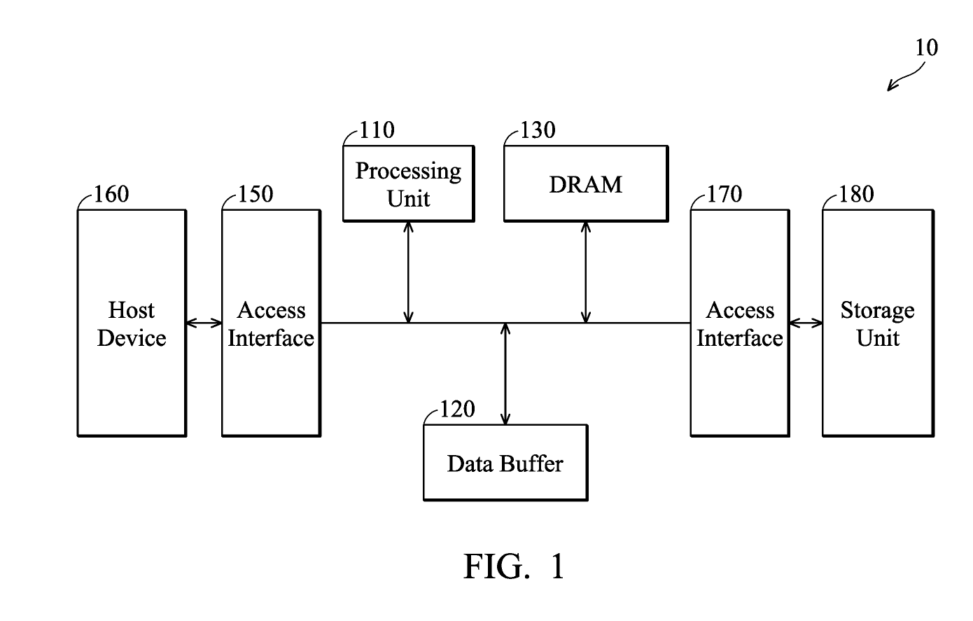

FIG. 1 is the system architecture of a flash memory according to an embodiment of the invention. The system architecture 10 of the flash memory contains a processing unit 110 being configured to write data into a designated address of a storage unit 180, and read data from a designated address thereof. Specifically, the processing unit 110 writes data into a designated address of the storage unit 10 through an access interface 170 and reads data from a designated address thereof through the same interface 170. The system architecture 10 uses several electrical signals for coordinating commands and data transfer between the processing unit 110 and the storage unit 180, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc. The access interface 170 may communicate with the storage unit 180 using a SDR (Single Data Rate) protocol or a DDR (Double Data Rate) protocol, such as ONFI (open NAND flash interface), DDR toggle, or others. The processing unit 110 may communicate with the host device 160 through an access interface 150 using a standard protocol, such as USB (Universal Serial Bus), ATA (Advanced Technology Attachment), SATA (Serial ATA), PCI-E (Peripheral Component Interconnect Express) or others.

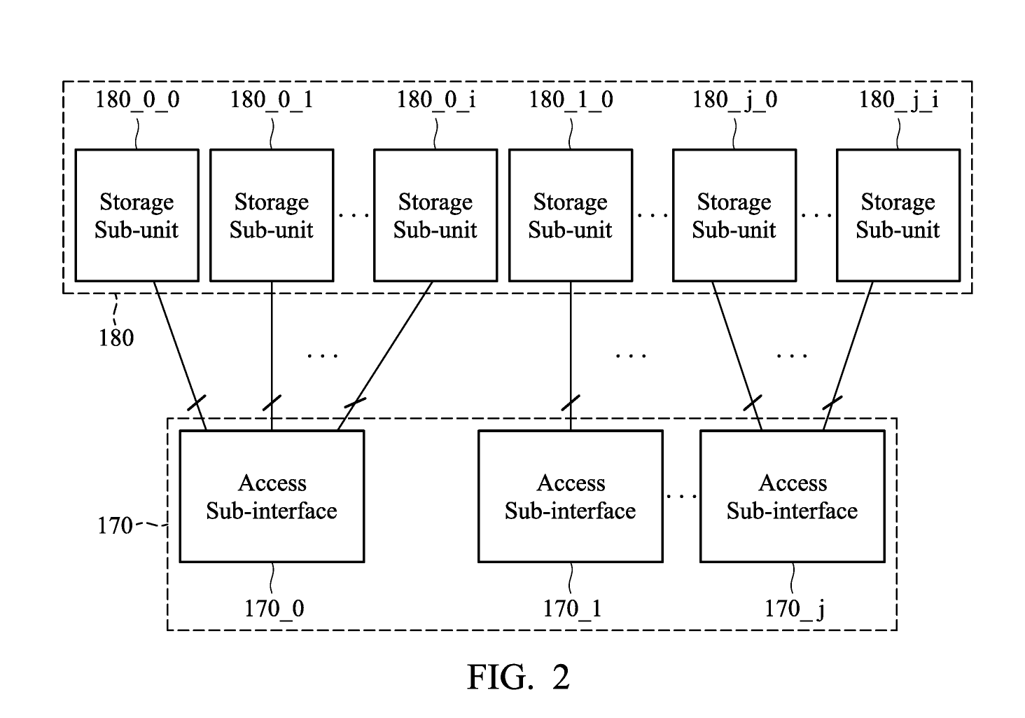

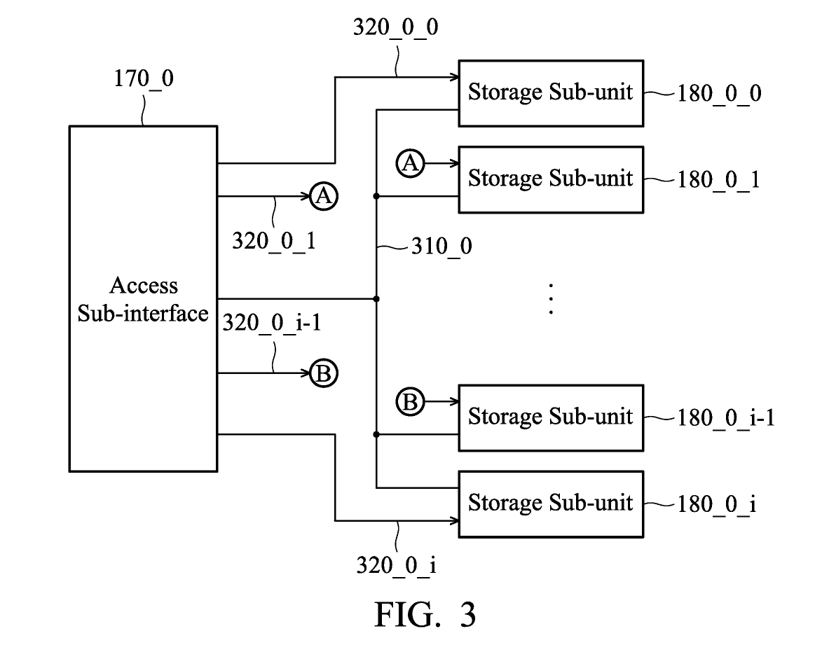

The storage unit 180 may contain multiple storage sub-units and each storage sub-unit may be practiced in a single die and use an access sub-interface to communicate with the processing unit 110. FIG. 2 is a schematic diagram illustrating interfaces to storage units of a flash storage according to an embodiment of the invention. The flash memory 10 may contain j+1 access sub-interfaces 170_0 to 170_j, where the access sub-interfaces may be referred to as channels, and each access sub-interface connects to i+1 storage sub-units. That is, i+1 storage sub-units may share the same access sub-interface. For example, assume that the flash memory contains 4 channels (j=3) and each channel connects to 4 storage sub-units (i=3): The flash memory 10 has 16 storage sub-units 180_0_0 to 180_j_i in total. The processing unit 110 may direct one of the access sub-interfaces 170_0 to 170_j to read data from the designated storage sub-unit. Each storage sub-unit has an independent CE control signal. That is, it is required to enable a corresponding CE control signal when attempting to perform data read from a designated storage sub-unit via an associated access sub-interface. It is apparent that any number of channels may be provided in the flash memory 10, and each channel may be associated with any number of storage sub-units, and the invention should not be limited thereto. FIG. 3 is a schematic diagram depicting connections between one access sub-interface and multiple storage sub-units according to an embodiment of the invention. The processing unit 110, through the access sub-interface 170_0, may use independent CE control signals 320_0_0 to 320_0_i to select one of the connected storage sub-units 180_0_0 and 180_0_i, and then read data from the designated location of the selected storage sub-unit via the shared data line 310_0.

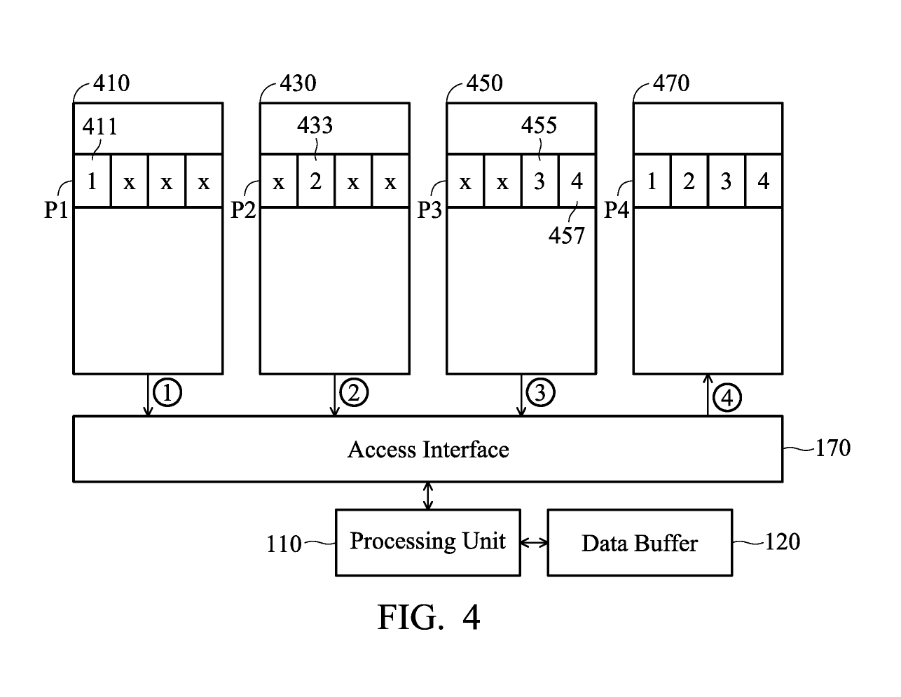

FIG. 4 is a schematic diagram of GC according to an embodiment of the invention. Assume one page stores data of four sections: Through being accessed several times, the 0^{th} section 411 of the page P1 of the block 410 contains good data and the remaining sections contain stale data. The 1^{st} section 433 of the page P2 of the block 430 contains good data and the remaining sections contain stale data. The 2^{nd} and 3^{rd} sections 455 and 457 of the page P3 of the block 450 contain good data and the remaining sections contain stale data. In order to collect good data of the pages P1 to P3 in one page so as to store the good data in a new page P4 of the block 470, the GC process is performed. Specifically, space in the data buffer 120 is allocated to store one page of data. The processing unit 110 may read data of the page P1 from the block 410 via the access sub-interface 170, hold data of the 0^{th} section 411 of the page P1 and store it in the 0^{th} section of the allocated space of the data buffer 120. Next, the processing unit 110 may read data of the page P2 from the block 430 via the access sub-interface 170, hold data of the 1^{st} section 433 of the page P2 and store it in the 1^{st} section of the allocated space of the data buffer 120. Next, the processing unit 110 may read data of the page P3 from the block 450 via the access sub-interface 170, hold data of the 2^{nd} and 3^{rd} sections 455 and 457 of the page P3 and store it in the 2^{nd} and 3^{rd} sections of the allocated space of the data buffer 120. Finally, the processing unit 110 may program data of the allocated space of the data buffer 120 into the page P4 of the block 470.

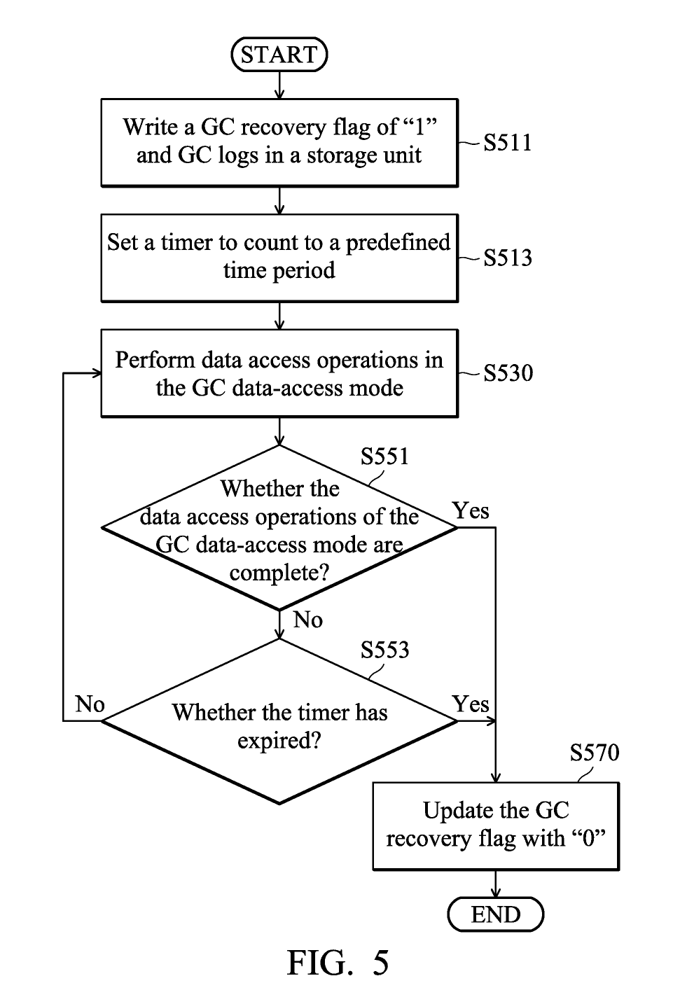

The processing unit 110 writes a GC recovery flag in the storage unit 180 (that is, non-volatile storage space) to indicate whether the flash memory needs a POR (Power Off Recovery). For example, the GC recovery flag being “0” indicates that the flash memory does not need a POR. The GC recovery flag being “1” indicates that the flash memory needs a POR. FIG. 5 is a flowchart illustrating a method for GC data accesses according to an embodiment of the invention. The method is performed when relevant microcode, macrocode or software instructions are loaded and executed by the processing unit 110. When a GC data-access mode is entered, the access interface 170 is directed to write the GC recovery flag of “1” and GC logs in the storage unit 180, where the GC logs contains information about a destination block and good-data sections to be collected (step S511) and a timer is set to count to a predefined time period (step S513). The setting to the timer ensures that the performance of GC data-access operations does not exceed the predefined time period so as to avoid hindering regular data-access operations. The regular data-access operations may contain data accesses for responding to data read and write commands issued by the host device 160. It should be noted that any information about good-data sections being presented in GC logs indicates unfinished GC data-access operations. Next, after an iteration for performing data access operations in the GC data-access mode (step S530), it is determined whether the data access operations of the GC data-access mode are complete (step S551) and whether the timer has expired (step S553). In step S530, each time a iteration is successfully executed for performing data access operations of the GC data-access mode, the processing unit 110 updates the GC logs to remove information about the good-data sections whose data has been collected and written in the storage unit 180. In step S551, the processing unit 110 may inspect whether the GC logs contain any information about good-data sections to be collected. When the GC logs contain no information about good-data sections to be collected, the data access operations of the GC data-access mode are complete. When the data access operations of the GC data-access mode are complete (the “Yes” path of step S551), or the timer has expired (the “Yes” path of step S553), the GC recovery flag of the storage unit 180 is updated with “0” (step S570). In step S530, the processing unit 110 may perform a predefined time period, data volume or transactions of the data access operations of the GC data-access mode. In some embodiments, in step S513, the processing unit 110 may additionally store an expiration flag that is initiated to “0” in the DRAM (Dynamic Random Access Memory) 130. When the timer has counted to the predefined time period (also referred to as a timer time-out), the expiration flag of the DRAM 130 is set to “1”. In step S533, the processing unit 110 may inspect the expiration flag of the DRAM 130 to determine whether the timer has expired. In alternative embodiments, when predefined time period has been counted, the timer may issue an interrupt to the processing unit 110 to trigger an ISR (Interrupt Service Routine) with a high priority that interrupts the currently performed data access operations of the GC data-access mode and sets the GC recovery flag to “0” (step S570).

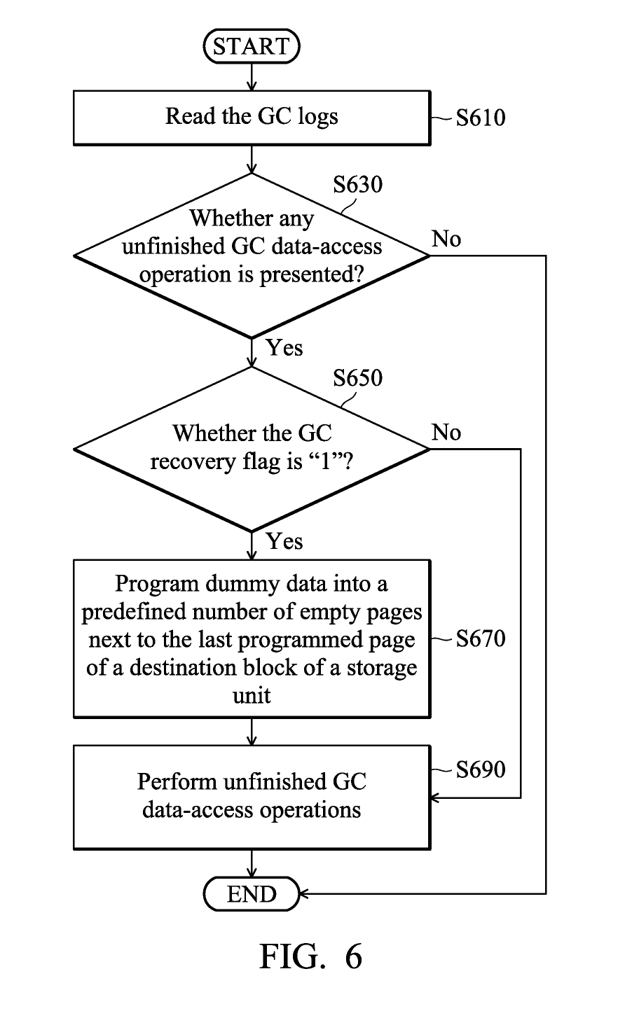

After a reboot subsequent to a power-off event, the processing unit 110 performs a method for GC POR of a boot procedure to continue unfinished GC data-access operations. FIG. 6 is a flowchart illustrating a method for GC POR according to an embodiment of the invention. The processing unit 110 directs the access interface 170 to read the GC logs from the storage unit 180 (step S610), it is determined whether any unfinished GC data-access operation is presented (step S630). When no unfinished GC data-access operation is presented (the “No” path of step S630), the whole process ends. When any unfinished GC data-access operation is presented (the “Yes” path of step S630), the processing unit 110 directs the access interface 170 to read the GC recovery flag from the storage unit 180 and determines whether the GC recovery flag is “1” (step S650). When the GC recovery flag of the storage unit 180 is “1” (the “Yes” path of step S650), information about a destination block (that is, an empty or available block) is obtained from the GC logs and dummy data is programmed into a predefined number of empty pages next to the last programmed page of the destination block of the storage unit 180 (step S670), and the information about the good-data sections to be collected is obtained from the GC logs and the access interface 170 is directed to perform unfinished GC data-access operations accordingly (step S690). When the GC recovery flag of the storage unit 180 is “0” (the “No” path of step S650), the information about the destination block and the good-data sections to be collected is obtained from the GC logs and the access interface 170 is directed to perform unfinished GC data-access operations accordingly (step S690). It should be noted that the GC recovery flag of the storage unit 180 and the determination of step S650 can be used to avoid a programming of unnecessary dummy data to waste storage space of the storage unit 180.

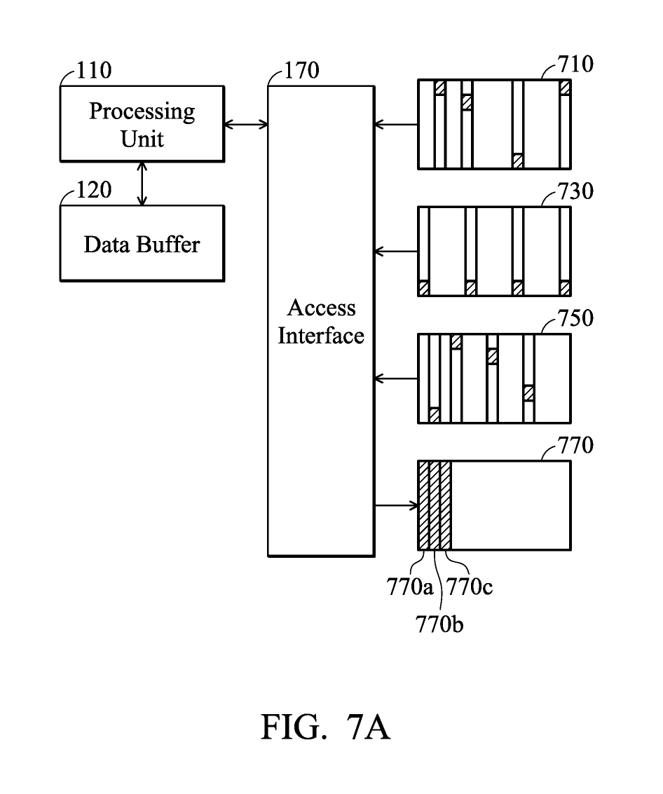

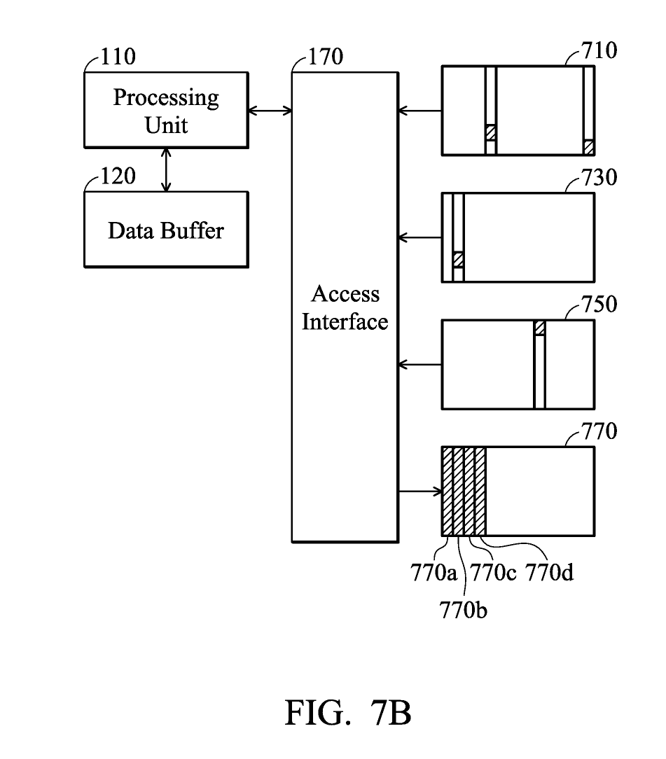

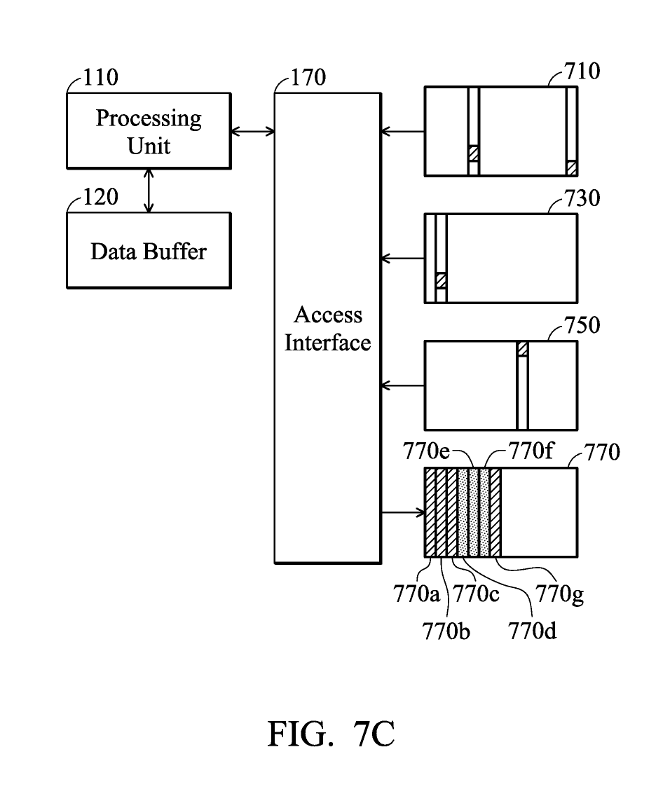

Scenarios are introduced to illustrate the aforementioned methods of FIGS. 5 and 6. FIGS. 7A-7C are schematic diagrams of GC according to an embodiment of the invention.

The first scenario describes that a sudden power off induced by a natural or man-made disaster does not happen during a programming to the available block. Therefore, no empty page of the available block is damaged. Refer to FIG. 7A. The processing unit 110 uses one or more batches to collect data of good-data sections of the blocks 710, 730 and 750 (as shown in slashed boxes) and program the collected data in an aggregate into three empty pages 770a, 770b and 770c of the available block 770 (step S530). Assume that the timer has expires and the GC logs contains un-finished GC data-access operations after the data of the good-data sections is programmed into the three empty pages 770a, 770b and 770c: When detecting that the timer has expired (the “Yes” path of step S553), the processing unit 110 updates the GC recovery flag of the storage unit 180 with “0” (step S570). After that, a sudden power off induced by a natural or man-made disaster happens. Refer to FIG. 7B. After a reboot since the sudden power off, the processing unit 110 reads the GC logs (step S610) and detects that unfinished GC data-access operations are presented and the GC recovery flag is “0” (the “No” path of step S650 following the “Yes” path of step S630). Then, the processing unit 110 performs the unfinished GC data-access operations to collect data of good-data sections of the blocks 710, 730 and 750 (as shown in slashed boxes) and program the collected data in an aggregate into an empty page 770d of the available block 770 (step S690).

The second scenario describes that a sudden power off induced by a natural or man-made disaster happens during a programming to the available block. Therefore, one or more empty page of the available block are damaged. Refer to FIG. 7B. Assume that a sudden power off induced by a natural or man-made disaster happens when the processing unit 110 uses one or more batches to collect data of good-data sections of the blocks 710, 730 and 750 (as shown in slashed boxes) and program the collected data in an aggregate into three empty pages 770a, 770b and 770c of the available block 770 (step S530). Refer to FIG. 7C. After a reboot since the sudden power off, the processing unit 110 reads the GC logs (step S610) and detects that unfinished GC data-access operations are presented and the GC recovery flag is “1” (the “Yes” path of step S650 following the “Yes” path of step S630). Then, the processing unit 110 programs dummy data into the next three empty pages 770d, 770e and 770f of the available block 770 (step S670) and collects data of good-data sections of the blocks 710, 730 and 750 (as shown in slashed boxes) and program the collected data in an aggregate into an empty page 770g of the available block 770 (step S690).

Although the embodiment has been described as having specific elements in FIGS. 1-3, it should be noted that additional elements may be included to achieve better performance without departing from the spirit of the invention. While the process flows described in FIGS. 5-6 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for GC (garbage collection) POR (Power Off Recovery), performed by a processing unit, comprising:
after a reboot subsequent to a power-off event, reading a GC recovery flag from a storage unit and determining whether the GC recovery flag indicates that a flash memory needs a POR; and
when the GC recovery flag indicates that the flash memory needs a POR, programming dummy data into a predefined number of empty pages next to the last programmed page of a destination block of the storage unit and performing an unfinished GC data-access operation.

2. The method of claim 1, comprising:
when the GC recovery flag indicates that the flash memory does not need a POR, performing the unfinished GC data-access operation.

3. The method of claim 2, wherein information about the destination block is obtained from a GC log.

4. The method of claim 3, wherein the GC log comprises information about good-data sections of the storage unit to be collected.

5. The method of claim 1, wherein the storage unit provides non-volatile storage space.

6. The method of claim 1, wherein the unfinished GC data-access operation collects data of a plurality of good-data sections and programs the collected data in an aggregate into the destination block of the storage unit.

7. The method of claim 1, comprising:
after the reboot subsequent to the power-off event, reading a GC log comprising information about the destination block and good-data sections to be collected.

8. The method of claim 7, wherein the unfinished GC data-access operation is performed according to the information about the GC log that indicates the destination block and the good-data sections to be collected.

9. An apparatus for GC (garbage collection) POR (Power Off Recovery), comprising:
an access interface, coupled to a storage unit; and
a processing unit, coupled to the access interface, after a reboot subsequent to a power-off event, reading a GC recovery flag from the storage unit and determining whether the GC recovery flag indicates that a flash memory needs a POR; and when the GC recovery flag indicates that the flash memory needs a POR, directing the access interface to program dummy data into a predefined number of empty pages next to the last programmed page of a destination block of the storage unit and performing an unfinished GC data-access operation.

10. The apparatus of claim 9, wherein the processing unit, when the GC recovery flag indicates that the flash memory does not need a POR, performs the unfinished GC data-access operation.

11. The apparatus of claim 10, wherein information about the destination block is obtained from a GC log.

12. The apparatus of claim 11, wherein the GC log comprises information about

13. The apparatus of claim 9, wherein the storage unit provides non-volatile storage space.

14. The apparatus of claim 9, wherein the unfinished GC data-access operation collects data of a plurality of good-data sections and programs the collected data in an aggregate into the destination block of the storage unit.

15. The apparatus of claim 9, wherein the processing unit, after the reboot subsequent to the power-off event, reads a GC log comprising information about the destination block and good-data sections to be collected.

16. The apparatus of claim 15, wherein the processing unit performs the unfinished GC data-access operation according to the information about the GC log that
